(19) United States
(12) Patent Application Publication
(10) Pub. No.: US 2010/0157586 A1
(43) Pub. Date: Jun. 24, 2010

(54) Illuminative module for emitting white light via mixing the primary colors with fourth color

(76) Inventor: Joe Yang, Taichung City (TW)

Correspondence Address: CHARLES E. BAXLEY, ESQUIRE, 90 JOHN STREET, SUITE 309, NEW YORK, NY, 10038, US

(21) Appl. No.: 12/317,516

(22) Filed: Dec. 24, 2008

(51) Int. Cl. F21K 7/00; F21V 21/00

(52) U.S. Cl. 362/230; 362/249.01; 362/249.02

(57) ABSTRACT

Disclosed is an illuminative module for enhancing the white balance while reducing thermal drift and color spots. The illuminative module includes a substrate and light-emitting elements provided on the substrate to emitting light of the primary colors and a fourth color, respectively, so that the light of the primary colors is mixed with the light of the fourth color to provide white light.

### FIELD OF INVENTION

The present invention relates to an illuminative module for emitting white light via physical mixture of the primary colors with a fourth color, thus enhancing white balance while reducing thermal drift and color spots.

### BACKGROUND OF INVENTION

Epitaxy is used to manufacture photoelectric elements such as light-emitting diodes to emit light based on the electro-luminescence conversion effect. Efforts have been made to develop light-emitting diodes for illumination. There is a trend to use light-emitting diodes instead of current illuminative devices.

Referring to FIG. 1, a conventional light-emitting diode (“LED”) 1 includes a single chip 12, a fluorescent layer 13 provided on the chip 12 and resin 11 for wrapping the chip 12 and the yellow fluorescent layer 13. Based on the electro-luminescence conversion effect, the chip 12 emits blue light. The blue light turns the electrons of the chemical structure of the fluorescent layer 13 into an excited state from a ground state. In the excited state, the fluorescent layer 13 emits yellow light. The blue light is mixed with the yellow light, thus providing white light. This is called chemical color mixture. More details of the LED 1 can be found in U.S. Pat. No. 6,765,237 issued to Nichia.

The LED 1 is the mainstream product because processes for making and using it are simple. However, the fluorescent layer 13 is vulnerable to heat generated with the chip 12 so that the wavelength of the light emitted from the LED 1 changes, and the intensity of the illumination or luminance of the LED 1 decays. This is called the “fluorescent decay.”

Sunlight consists of red light, orange light, yellow light, green light, blue light, indigo light and purple light. Red, green and blue are called the “primary colors” because the other colors can be achieved by mixing at least some of the primary colors. In the LED 1, the blue light emitted from the chip 12 excites the fluorescent layer 13 to emit yellow light. Red and green are not included in the white light emitted from the LED 1. Therefore, the saturation and color-rendering property of the white light emitted from the LED 1 are poor. That is, the LED 1 is not suitable for illumination that requires a good color-rendering property.

Currently, most light-emitting diodes emit white light based on the chemical color mixture. There are problems with such light-emitting diodes. For example, expansive heat radiation must be devised for an LED used in a streetlamp. This problem has not been overcome.

To avoid problems with the light-emitting diodes based on the chemical color mixture, the present applicant has devised an LED based on physical color mixture. The LED includes a chip for emitting blue light and another chip for emitting yellow light so that the blue light is mixed with the yellow light to provide white light.

Referring to FIG. 2, there is shown a conventional multi-chip LED including a chip for emitting red light, another chip for emitting green light and another chip for emitting blue light. The wavelengths and intensities of the light of the primary colors must be carefully selected. Even with careful selection, white light only exists in an area where the light beams of the primary colors overlap. Light turns to the primary colors away from the area. There are various color spots.

The wavelength of light emitted from an LED is determined by the structure of the epitaxy, materials used therein and the matching of lattices. The wavelength of the light emitted from the LED suffers thermal drift. That is, at the moment when the multi-chip LED approach is actuated, the intensity of the red light is high so that the white light tends to be a warm color. As the operation of the multi-chip LED goes on, the intensity of the blue light gets higher so that the white light tends to be a cold color. The thermal drift of the white light might be too big to achieve a good white balance. The intensity of illumination would be compromised accordingly.

Referring to FIG. 3, a conventional lamp includes a white light (“WL”) LED, a red light (“RL”) LED, a green light (“GL”) LED and a blue light (“BL”) LED. The WL LED is used as a major light source while the RL LED, GL LED and BL LED are used as color temperature-compensating units. If necessary, at least some of the color temperature-compensating units are activated to emit light to compensate the changes in the color temperature of white light emitted from the WL LED due to the thermal drift of the wavelength. An adjusting knob is manually operable to adjust the color temperature if the color temperature and luminance of the conventional lamp changes after some time of use. It is inferred that the WL LED is based on the chemical color mixture. It is known that an LED according to the chemical color mixture suffers serious luminance decay because the fluorescent layer suffers inevitable decay caused by heat. Although it is intended to compensate the change in the color temperature of the WL LED with the RL LED, GL LED and BL LED, this attempt is impractical. Besides, the change in the color temperature of the WL LED is not avoided.

Referring to FIG. 4, a conventional back light module used in a liquid crystal display includes two rows of light-emitting diodes 21 provided on a printed circuit board 2. In each row, there are red light-emitting diodes, green light-emitting diodes and blue light-emitting diodes. At each end of each row where color difference is most likely to occur, there is a white light-emitting diode. Near each end of each row, red, green or blue light is mixed with white light to provide pink, light-green light or indigo light. Obviously, the white light-emitting diodes alleviate the color difference, not eliminate. The white light-emitting diodes are based on chemical color mixture.

As discussed above, the white light-emitting diodes are based on the chemical color mixture no matter they are used as the major light sources or to compensate the light difference. There are always problems related to the fluorescent decay, color-rendering property and NTSC.

The present invention is therefore intended to obviate or at least alleviate the problems encountered in prior art.

### SUMMARY OF INVENTION

It is the primary objective of the present invention to provide an illuminative module for emitting white light via mixing the primary colors with a fourth color, thus enhancing the white balance while reducing thermal drift and color spots.

To achieve the foregoing objective, the illuminative module includes a substrate and light-emitting elements provided on the substrate to emitting light of the primary colors and a fourth color, respectively, so that the light of the primary colors is mixed with the light of the fourth color to provide white light.

Other objectives, advantages and features of the present invention will become apparent from the following description referring to the attached drawings.

### BRIEF DESCRIPTION OF DRAWINGS

The present invention will be described via the detailed illustration of four embodiments versus the prior art referring to the drawings.

FIG. 1 is a side view of a conventional light-emitting diode.

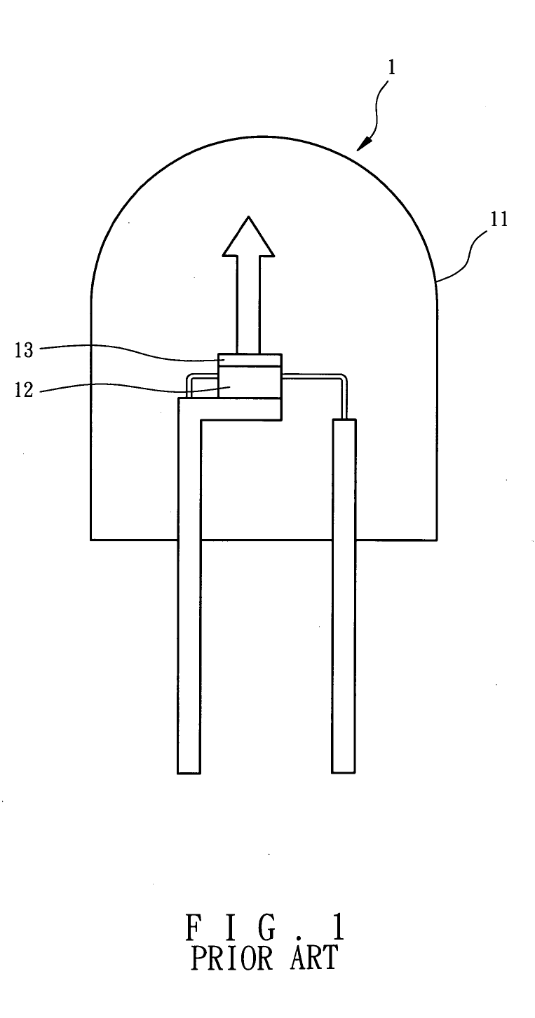

FIG. 2 is a side view of a conventional multi-chip LED approach.

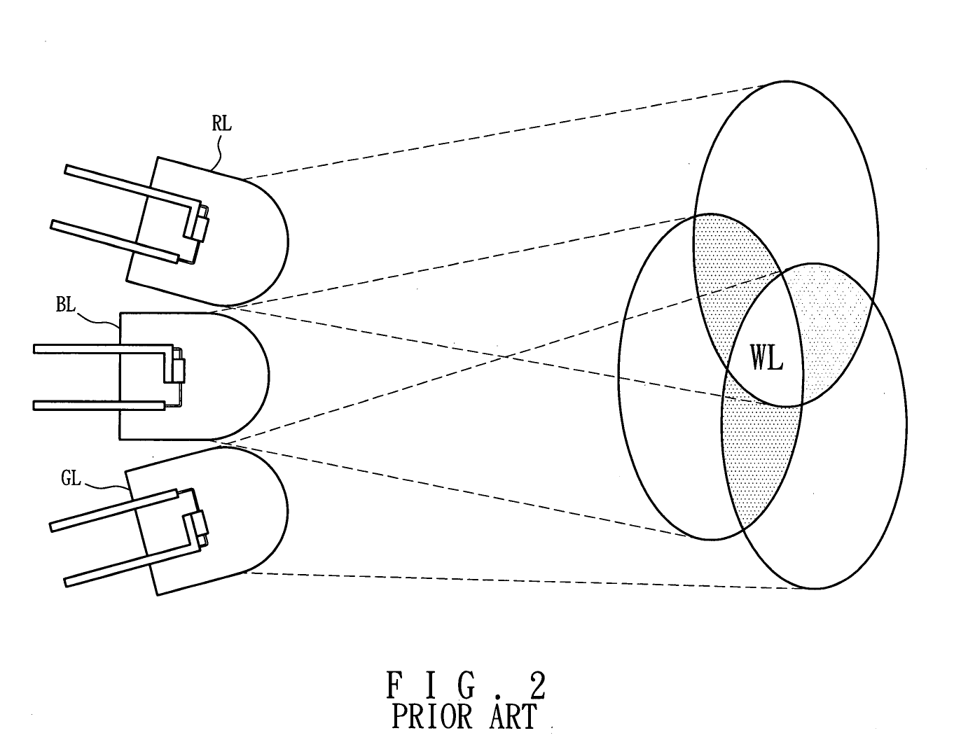

FIG. 3 is a block diagram of a conventional lamp consisting of a white light-emitting diode, a red light-emitting diode, a green light-emitting diode and a blue light-emitting diode.

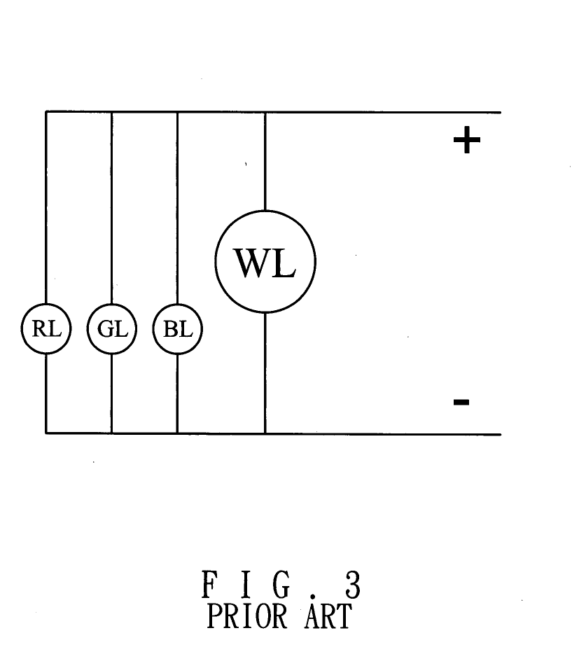

FIG. 4 is a block diagram of a conventional back light module with two rows of light-emitting diodes provided on a printed circuit board.

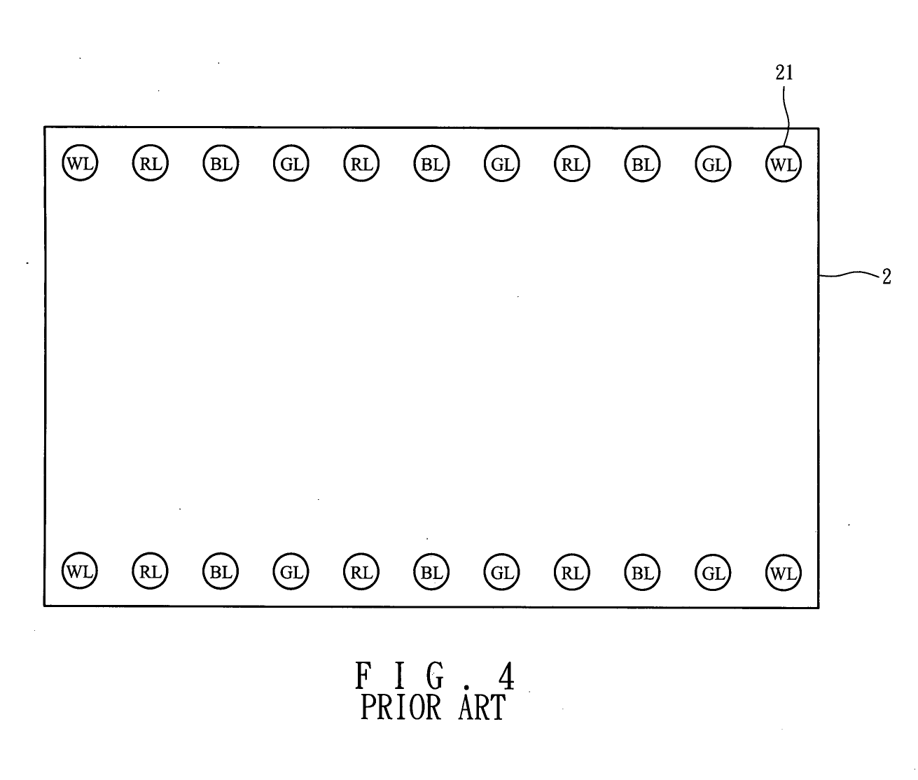

FIG. 5 is a block diagram of an illuminative module according to the first embodiment of the present invention.

FIG. 6 is a partial cross-sectional view of the illuminative module shown in FIG. 5.

FIG. 7 is a C.I.E. chromaticity diagram.

FIG. 8 is a partial side view of an illuminative module according to the second embodiment of the present invention.

FIG. 9 is a block diagram of an illuminative module according to the third embodiment of the present invention.

FIG. 10 is a block diagram of an illuminative module according to the fourth embodiment of the present invention.

### DETAILED DESCRIPTION OF EMBODIMENTS

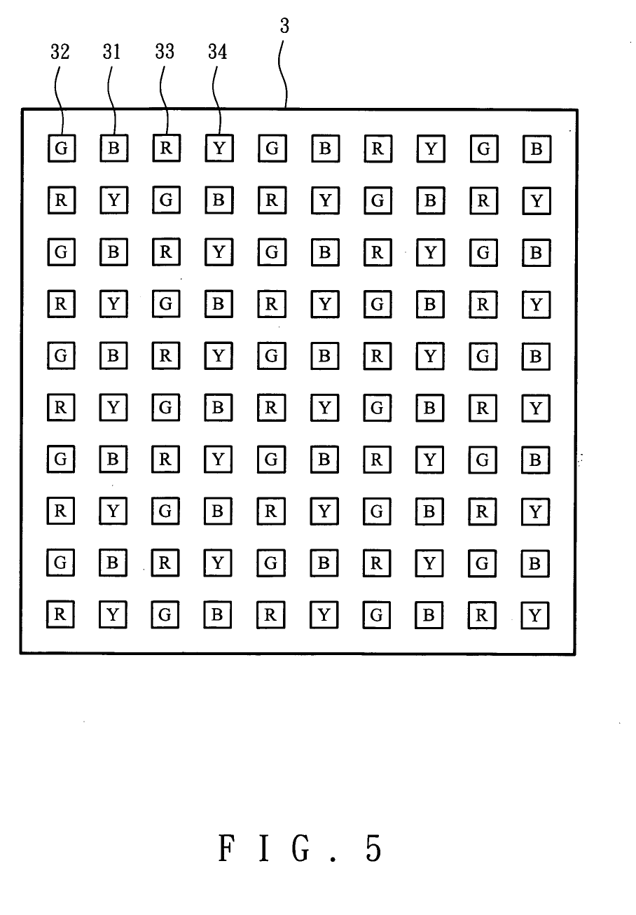

Referring to FIG. 5, an illuminative module includes a substrate 3 and an array of light-emitting elements provided on the substrate 3 according to a first embodiment of the present invention. The substrate 3 may be a printed circuit board.

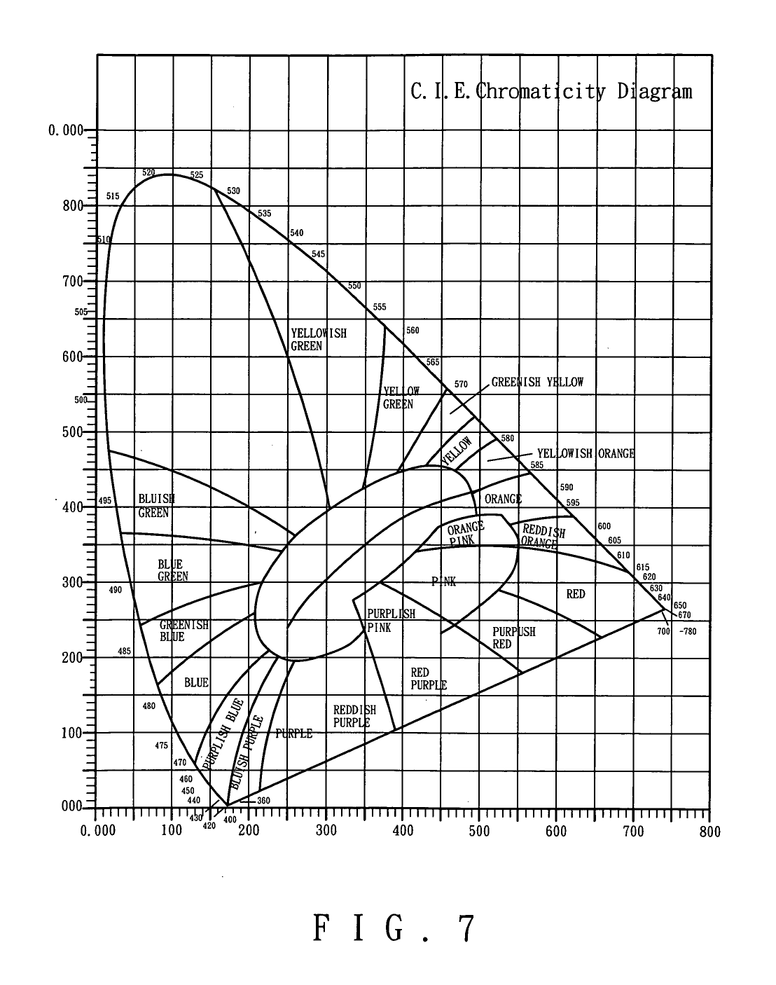

The light-emitting elements may be light-emitting diodes. The light-emitting elements include light-emitting elements 31 for emitting light of a first color, light-emitting elements 32 for emitting light of a second color, light-emitting elements 33 for emitting light of a third color and light-emitting elements 31 for emitting light of a fourth color. The first color is preferably blue, the second color green, and the third color red. Referring to FIG. 7, the fourth color may be yellow with a wavelength of 560 to 610 nanometers or cyan with a wavelength of 470 to 500 nanometers.

The light-emitting elements 31, 32 and 33 are arranged in any proper order on the substrate 3. Preferably, each of the light-emitting elements 31, 32 and 33 includes a single light-emitting chip. Preferably, the light-emitting elements 31, 32 and 33 emit light of the primary colors, respectively, so that the light is mixed to provide white light. Based on the efficiencies of the light-emitting elements 31, 32 and 33, the white light might be greenish, reddish or bluish white light. Preferably, the light-emitting elements 34 emit yellow light. Yellow light is the mixture of red light with green light. Yellow light can be mixed with blue light to provide white light. Therefore, it is important that the light-emitting elements 34 emit yellow light.

Referring to FIG. 7, the wavelength of white light is located in the center of the C.I.E. chromaticity diagram. Yellow light can be mixed with greenish white light so that the color temperature is close to the center of the C.I.E. chromaticity diagram. The thermal drift of the wavelength is reduced in the C.I.E. chromaticity diagram, and the white balance is increased accordingly. Similarly, yellow light can be mixed with reddish or bluish white light so that the color temperature is close to the center of the C.I.E. chromaticity diagram. The thermal drift of the wavelength is reduced in the C.I.E. chromaticity diagram, and the luminance is close to that of truly white light.

Moreover, when the primary colors are mixed with one another to provide white light, there are various colors in areas other than the center of the chromaticity diagram. However, the yellow light is mixed with the light of various colors so that the color temperature is close to that of the white light, thus reducing color spots.

The illuminative module of the present invention is different from the conventional LED based on the chemical color mixture discussed in the Related Prior Art. Firstly, the white light emitted from the illuminative module of the present invention is the mixture of light of the primary colors and the fourth color so that the color phase thereof is better than the white light as the mixture blue light with yellow light according to the chemical color mixture, and so is the color-rendering property.

Secondly, each of the light-emitting elements 31, 32, 33 and 34 includes a single chip. The light-emitting elements 31, 32 and 33 emit light of the primary colors, respectively. The primary colors are mixed with the fourth color to provide white color. Heat produced due to the electro-luminescence effect does not affect the light-emitting elements 31, 32, 33 and 34 seriously. On the contrary, heat generated due to the electro-luminescence effect entails the degrading of the fluorescent layer of the conventional LED and the fluorescent decay, thus affecting the resultant white light.

Moreover, the illuminative module of the present invention is different from the conventional illuminative device based on the color temperature-compensation discussed in the Related Prior Art. Firstly, the large number of light-emitting elements 31, 32, 33 and 34 emit light of four non-white colors, and the non-white colors are mixed with one another to provide white without having to include a complicated device to adjust the currents provided to different light-emitting elements. That is, after the illuminative module is made, the wavelengths are controlled so that the resultant white light is close to truly white light and that the number of the color spots is contained in an acceptable range without the need for the color temperature compensation.

Secondly, the wavelengths of the non-white colors are determined when the illuminative module of the present invention is made. The combination of the wavelengths and the color temperature of the resultant white color do not change much. Therefore, the thermal drift is small and the white balance is good. On the contrary, according to the color temperature-compensation, the white LED is used as the major light source together with color temperature-compensating units. The color temperature of the white LED changes unpredictably because of the fluorescent decay of the fluorescent layer in the white LED so that the result of the color temperature-compensation is unpredictable.

The illuminative module of the present invention is different from the back light module based on the color difference compensation discussed in the Related Prior Art. Firstly, the light-emitting elements 31, 32, 33 and 34 emit light of four colors that is mixed to provide white light without any color difference. In the conventional back light module, the color difference compensation can only achieve white light in a short period of time, and the color difference gets worse soon after that short period of time.

Secondly, the brightness and luminance of the resultant white light emitted from the illuminative module of the present invention are higher than those of the resultant white light emitted from the conventional back light module.

Thirdly, the number of the color spots produced with the illuminative module of the present invention is smaller than the number of the color spots produced with the conventional back light module.

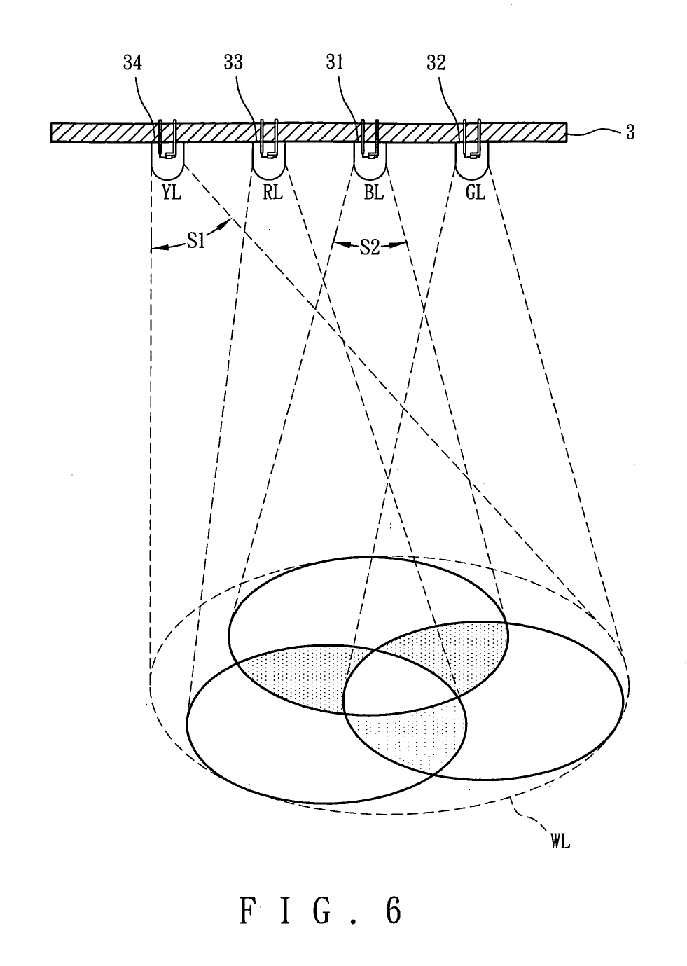

Referring to FIG. 6, an illuminative module includes light-emitting elements 31, 32, 33 and 34 according to a second embodiment of the present invention. The light-emitting element 31 emits blue light. The light-emitting element 32 emits green light. The light-emitting element 33 emits red light. The light-emitting element 34 emits yellow light.

Each of the light-emitting elements 31, 32, 33 and 34 is an LED. The illumination angle S1 of the light-emitting element 34 is larger than the illumination angle S2 of the light-emitting elements 31, 32 and 33. Thus, the light spot of the light-emitting element 34 is larger than the light sports of the light-emitting elements 31, 32 and 33. Hence, white light is provided within almost all of the light spot of the light-emitting element 34, thus reducing the number of color spots.

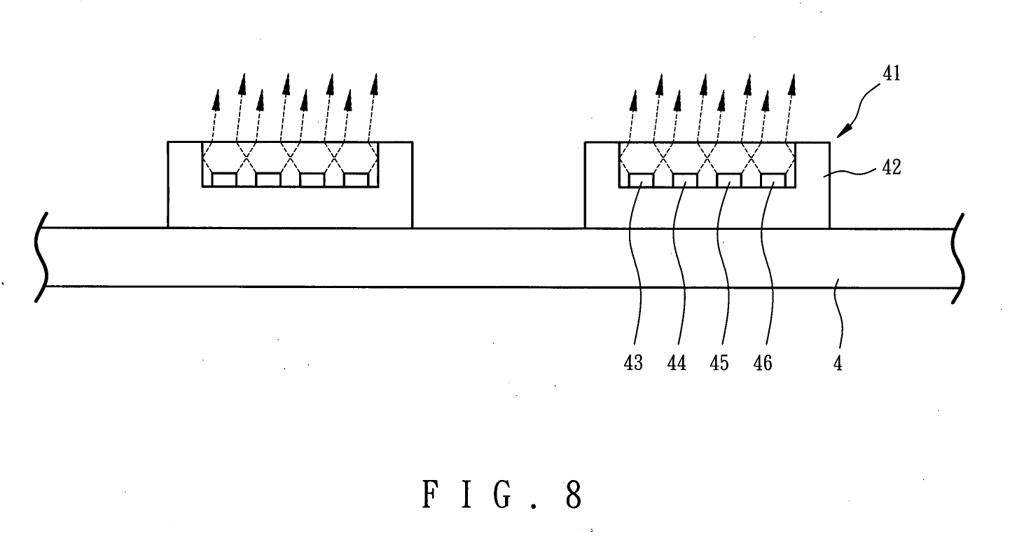

Referring to FIG. 8, an illuminative module includes light-emitting elements 41 provided on a substrate 4 according to a third embodiment of the present invention. Each of the light-emitting elements 41 includes chips 43, 44, 45 and 46 provided on a package substrate 42 for emitting red, green, blue and yellow light, respectively. Non-white light beams radiated from the chips 43, 44, 45 and 46 are mixed with one another to provide what light.

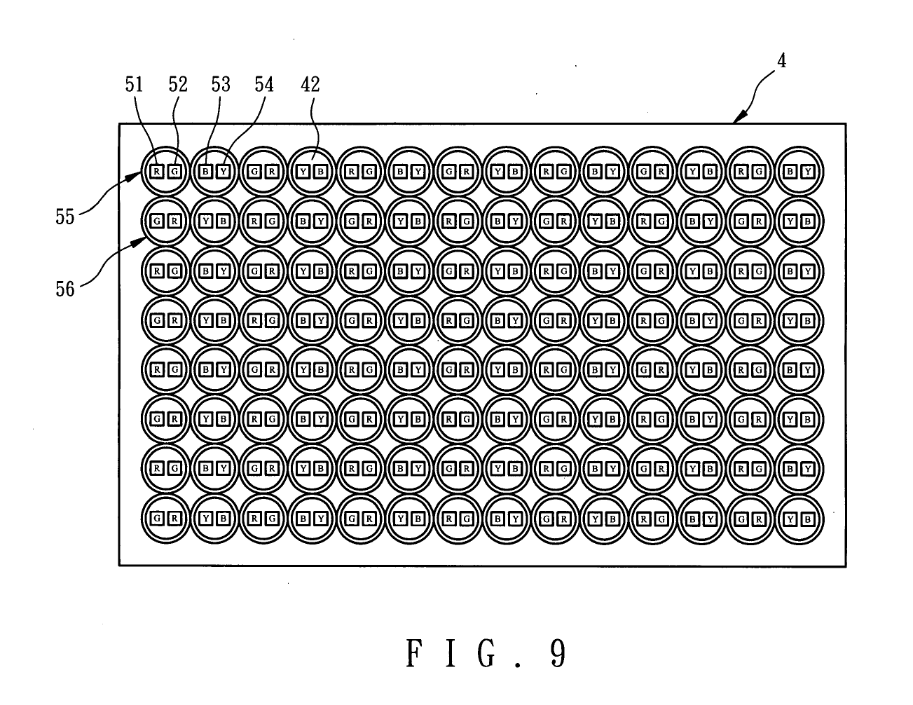

Referring to FIG. 9, an illuminative module includes light-emitting elements 55 and 56 provided on a substrate 4 according to a fourth embodiment of the present invention. Each of the light-emitting elements 55 includes two chips 51 and 52 provided on a package substrate 42 for emitting red and green light, respectively. Thus, the light-emitting elements 55 emit yellow light. Each of the light-emitting elements 56 includes two chips 53 and 54 provided on a package substrate 42 for emitting blue and yellow light, respectively. Thus, the light-emitting elements 56 emit white light. The yellow light emitted from the light-emitting elements 55 is mixed with the white light emitted from the light-emitting elements 56 to provide brighter white light.

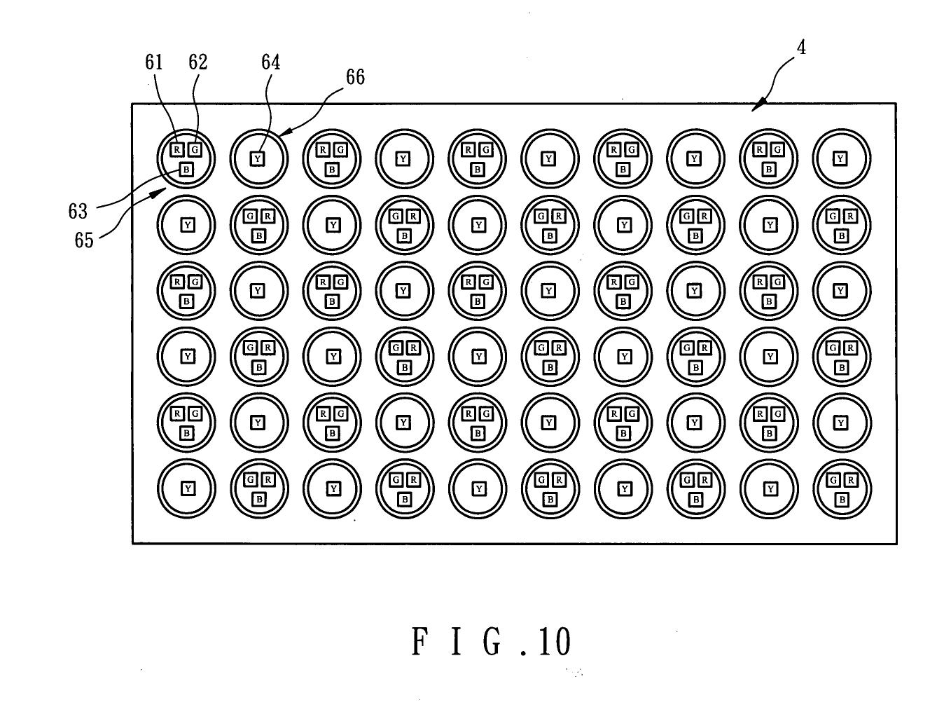

Referring to FIG. 10, an illuminative module includes light-emitting elements 65 and 66 provided on a substrate 4 according to a fifth embodiment of the present invention. Each of the light-emitting elements 65 includes three chips 61, 62 and 63 provided on a package substrate 42 for emitting red, green and blue light, respectively. Thus, the light-emitting elements 65 emit white light. Each of the light-emitting elements 66 includes a chip 64 provided on a package substrate 42 for emitting yellow light. The white light emitted from the light-emitting elements 65 is mixed with the yellow light emitted from the light-emitting elements 66 to provide brighter white light. The color-rendering property and white balance of the white light emitted from the illuminative module are good while the thermal drift and number of color spots are reduced.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An illuminative module for enhancing the white balance while reducing thermal drift and color spots, the illuminative module comprising a substrate and light-emitting elements provided on the substrate to emitting light of the primary colors and a fourth color, respectively, so that the light of the primary colors is mixed with the light of the fourth color to provide white light.

2. The illuminative module according to claim 1, wherein the substrate is a printed circuit board, each of the light-emitting elements is a light-emitting diode.

3. The illuminative module according to claim 2, wherein the light-emitting diode comprises a package substrate and at least one chip provided on the package substrate.

4. The illuminative module according to claim 1, wherein the wavelength of the fourth color is 560 to 610 nanometers.

5. The illuminative module according to claim 1, wherein the wavelength of the fourth color is 470 to 500 nanometers.

6. An illuminative module for enhancing the white balance while reducing thermal drift and color spots, the illuminative module comprising a substrate and light-emitting elements provided on the substrate, wherein each of the light-emitting elements comprises three chips for emitting light of the primary colors and another chip for emitting light of a fourth color.

7. The illuminative module according to claim 6, wherein the wavelength of the fourth color is 560 to 610 nanometers.

8. The illuminative module according to claim 6, wherein the wavelength of the fourth color is 470 to 500 nanometers.

9. An illuminative module for enhancing the white balance while reducing thermal drift and color spots, the illuminative module comprises a substrate and pairs of light-emitting elements provided on the substrate, wherein each of the pairs comprises first and second light-emitting elements for emitting light of the primary colors and a fourth color together.

10. The illuminative module according to claim 9 wherein the first light-emitting element emits light of two of the colors while the second light-emitting element emits light of the other colors.

11. The illuminative module according to claim 9 wherein the first light-emitting element emits light of the primary colors while the second light-emitting element emits light of the fourth color.

12. The illuminative module according to claim 9, wherein the wavelength of the fourth color is 560 to 610 nanometers.

13. The illuminative module according to claim 9, wherein the wavelength of the fourth color is 470 to 500 nanometers.
